(19) United States
(12) Patent Application Publication
(10) Pub. No.: US 2024/0289024 A1
(43) Pub. Date: Aug. 29, 2024

(54) STORAGE DEVICE, ELECTRONIC DEVICE AND METHOD FOR OPERATING ELECTRONIC DEVICE

(71) Applicant: SK hynix Inc., Icheon-si (KR)

(72) Inventor: Joon Seop SIM, Icheon-si (KR)

(21) Appl. No.: 18/357,886

(22) Filed: Jul. 24, 2023

(30) Foreign Application Priority Data
Feb. 23, 2023 (KR) 10-2023-0024055

(51) Int. Cl. G06F 3/06

(52) U.S. Cl. CPC G06F 3/0613; G06F 3/0659; G06F 3/0673

(57) ABSTRACT

In an embodiment of the disclosed technology, a storage device includes a circuit board, a memory disposed on the circuit board and including a plurality of memory cells configured to store data, and an internal processor coupled to be in communication with the memory and configured to perform an operation on the data stored in the memory upon receipt of a command from an external device, wherein the command is extracted based on an operational intensity of the operation to be performed in response to the command, in a process in which a compiler generates an instruction according to a program executed by an external processor that is disposed outside the memory and separate from the internal processor.

### CROSS-REFERENCE TO RELATED APPLICATION

This patent document claims the priority and benefits of Korean Patent Application No. 10-2023-0024055 filed on Feb. 23, 2023, which is incorporated herein by reference in its entirety.

### TECHNICAL FIELD

Various embodiments of the disclosed technology generally relate to a storage device, an electronic device and a method for operating an electronic device.

### BACKGROUND

In a computer architecture such as von Neumann architecture, a processor stores data in a memory that is separate from the processor. The processor reads data from or writes data to the memory to process the data.

### SUMMARY

Various embodiments relate to improving data processing efficiency of an electronic device including a processor and a memory and easily implementing the electronic device with improved data processing efficiency.

In an embodiment, a storage device includes a circuit board, a memory disposed on the circuit board and including a plurality of memory cells configured to store data, and an internal processor coupled to be in communication with the memory and configured to perform an operation on the data stored in the memory upon receipt of a command from an external device, wherein the command is extracted based on an operational intensity of the operation to be performed in response to the command, in a process in which a compiler generates an instruction according to a program executed by an external processor that is disposed outside the memory and separate from the internal processor.

In an embodiment, an electronic device may include a first processor configured to perform a first operation on data stored in a memory, and a second processor configured to perform a second operation on data stored in the memory in response to a command received from the first processor, wherein the command is extracted based on an operational intensity of an operation to be performed in response to the command, in a process in which a compiler generates an instruction according to a program executed by the first processor.

In an embodiment, a method for operating an electronic device may include executing a program by a first processor, comparing an operational intensity of an operation to be performed in response to a command with a preset reference value, in a process in which a compiler generates an instruction according to the program, and, in a case that the operational intensity of the operation to be performed in response to the command is less than the preset reference value, processing the command by a second processor located outside the first processor, or in a case that the operational intensity of the operation to be performed in response to the command is equal to or greater than the present reference value, processing the command by the first processor.

In an embodiment, a storage device may include: a memory including a plurality of memory cells; and an internal processor located inside the memory or on a circuit board on which the memory is mounted, and configured to perform an operation on data stored in the memory according to a command inputted from an outside, wherein the command is transmitted to the internal processor by being extracted on the basis of an operational intensity of an operation to be performed according to the command, in a process in which a compiler generates an instruction according to a program executed by an external processor separate from the internal processor.

In an embodiment, an electronic device may include: a first processor configured to perform an operation on data stored in a memory; and a second processor configured to perform an operation on data stored in the memory according to a command inputted from the first processor, the command being inputted by being extracted on the basis of an operational intensity of an operation to be performed according to the command, in a process in which a compiler generates an instruction according to a program executed by the first processor.

In an embodiment, a method for operating an electronic device may include: executing a program by a first processor; comparing an operational intensity of an operation to be performed according to a command and a preset reference value in a process in which a compiler generates an instruction according to the program; and processing, when an operational intensity of an operation to be performed according to the command is less than the present reference value, the command which is transmitted to a second processor located outside the first processor, and processing, when an operational intensity of an operation to be performed according to the command is equal to or greater than the present reference value, the command by the first processor.

According to the embodiments of the disclosed technology, a data processing environment by a processor located inside or adjacent to a memory may be easily implemented, thereby preventing a bottleneck phenomenon according to movement of data between the memory and the processor and improving data processing performance by the processor and the memory.

### BRIEF DESCRIPTION OF THE DRAWINGS

FIG. 1 is a diagram illustrating an example configuration of an electronic device based on an embodiment of the disclosed technology.

FIGS. 2 and 3 are diagrams illustrating example processes of accessing a storage device in the electronic device based on an embodiment of the disclosed technology.

FIG. 4 is a diagram illustrating an example of a reference value serving as a classification criterion for classifying a command to be processed by a processor in the electronic device based on an embodiment of the disclosed technology.

FIG. 5 is a diagram illustrating an example method for operating the electronic device based on an embodiment of the disclosed technology.

FIG. 6 is a diagram illustrating another example method for operating the electronic device based on an embodiment of the disclosed technology.

FIG. 7 is a diagram illustrating an example of a reference value that is adjusted according to the method illustrated in FIG. 6.

### DETAILED DESCRIPTION

Hereinafter, various embodiments of the disclosed technology will be described in detail with reference to accompanying drawings.

In some implementations, when a processor reads data from or writes data to a memory to process the data, data fetching and data processing do not occur at the same time and it takes time for the processor to fetch data to be processed from the memory, limiting the performance of the processor. The disclosed technology can be implemented to address such a bottleneck issue by using an internal processor located inside the memory or on a circuit board on which the memory is installed.

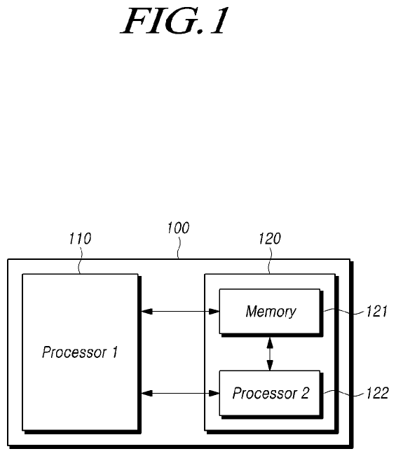

FIG. 1 is a diagram illustrating an example configuration of an electronic device 100 based on an embodiment of the disclosed technology.

Referring to FIG. 1, the electronic device 100 based on an embodiment of the disclosed technology may include a first processor 110 and a storage device 120.

Examples of the electronic device 100 may include any device that can store data and/or process data, such as a computer, a tablet computer and a mobile phone. In some implementations, the electronic device 100 may be a mobility device, such as a vehicle, a robot or a drone.

The first processor 110 may include a central processing unit (CPU) or graphics processing unit (GPU) to control the operation of the electronic device 100. The first processor 110 may include a control unit to control the overall operation of the electronic device 100 and may include a logic unit to perform a logical operation on data.

The first processor 110 may control the operation of the storage device 120. The first processor 110 may perform processing on data stored in the storage device 120. The first processor 110 may load data necessary for the operation of the first processor 110 into a memory 121 of the storage device 120, and may perform an operation by performing processing on the data stored in the memory 121.

The storage device 120 may be a data storage device that includes the memory 121 and a second processor 122.

The memory 121 may include a plurality of memory cells.

In an implementation, the memory 121 may be a volatile memory. In another implementation, the memory 121 may be a nonvolatile memory.

In an implementation, the second processor 122 may be located inside the storage device 120 and in communication with the memory 121. For example, the second processor 122 may be located inside the memory 121. In another implementation, the second processor 122 may be located on a circuit board on which the memory 121 is mounted and thus is separate from the memory 121. In various implementations, the second processor 122 may be a dedicated processor for the memory 121 that is separate from, and independent of, the first processor 110. In some implementations, the second processor 122 may operate in parallel with the first processor 110.

In an implementation where the second processor 122 is located inside the memory 121, the storage device 120 may be referred to as a “processing-in-memory” storage device that includes the second processor 122 that performs in-memory processing.

In an implementation where the second processor 122 is mounted on the same circuit board as the circuit board on which the memory 121 is mounted and is outside of the memory 121, the storage device 120 may be referred to as a “near data processing (NDP) memory.”

In an implementation where the second processor 122 is different from the first processor 110 and is located outside the memory 121, the length of a data bus or communication channel between the second processor 122 and the memory 121 may be shorter than the length of a data bus or communication channel between the first processor 110 and the memory 121.

The second processor 122 may perform operation processing on data stored in the memory 121.

An operation performed by the second processor 122 and an operation performed by the first processor 110 may be different or distinguished from each other.

In some implementations, the second processor 122 may be referred to as an “internal processor,” and the first processor 110 may be referred to as an “external processor.”

For example, the second processor 122 may operate according to a control signal provided by the first processor 110. The second processor 122 may receive a command from the first processor 110. In some implementations, the second processor 122 may read data from the memory 121 and perform an operation on the read data in response to the command received from the first processor 110.

The second processor 122 may perform a part of a data operation that may be performed by the first processor 110. In some implementations, the operation of the second processor 122 may be controlled by the first processor 110. Since an operation on data stored in the memory 121 is performed by the second processor 122 located inside the storage device 120, it is possible to address the performance bottleneck caused by the movement of data between the first processor 110 and the memory 121.

The operations to be performed by the second processor 122 may be determined based on the operations and commands executed by the first processor 110.

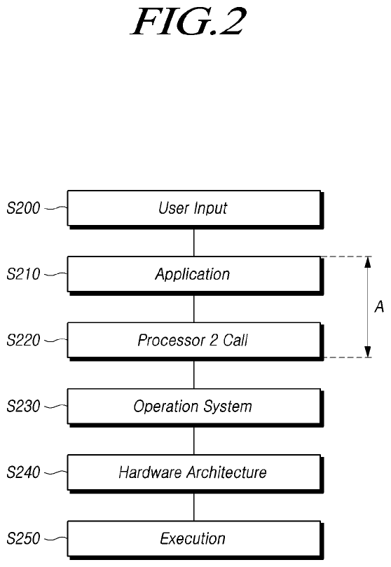

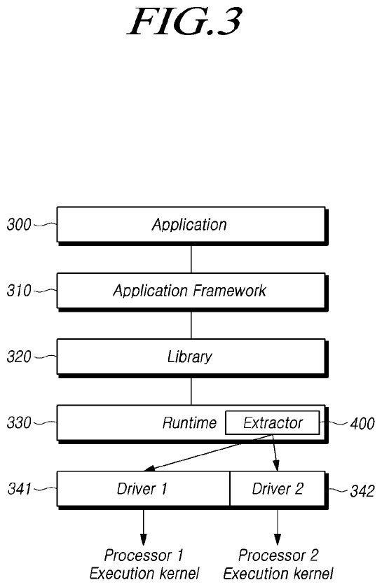

FIGS. 2 and 3 are diagrams illustrating example processes of accessing the storage device 120 in the electronic device 100 based on an embodiment of the disclosed technology.

Referring to FIG. 2, an application run by the electronic device 100 may be executed by the first processor 110 as shown by a series of operations by the first processor 110 as illustrated in S200 through S250.

When a user input occurs (S200), the application executed by the first processor 110 may receive the user input (S210). The application may call the second processor 122, which is located inside the storage device 120, based on the user input (S220) to make use of the second processor 122.

For example, when the application calls an operation that is supported by the second processor 122, the second processor 122 may generate an instruction corresponding to the operation. Once the second processor 122 completes its operation for which the first processor 110 calls at the step S220, the first processor 110 continues its operations through an operation system and a hardware architecture (S230 and S240) to execute an operation required according to the user input(S250).

In some implementations, a command for the application to call the second processor 122 of the storage device 120 may be different from a command to be executed by the first processor 110. In this case, in order to perform an access process indicated by A in FIG. 2, software for calling the second processor 122 needs to be separately implemented. Accordingly, a command to be performed by the first processor 110 and a command to be performed by the second processor 122 may be implemented using separate frameworks and libraries, and thus there may be a limitation on the data processing performance of the electronic device 100 using the second processor 122.

In some implementations, the term “application framework” or “framework” refers to a software framework or platform with built-in, ready-to-use software components and customizable features from which a software application can be selectively constructed with certain specific functions for the software application. A software library is a collection of various ready-to-use software codes or software routines with certain functions to be called or integrated into the operations of the application software.

The disclosed technology may be implemented in some embodiments improve the data processing performance of the electronic device 100 that includes the second processor 122 in the storage device 120. To this end, a command to be performed by the second processor 122 is generated and used through the same framework and library that generate a command to be performed by the first processor 110. In some implementations, the first processor and the second processor may be implemented by using the same framework and library. In some cases, different framework and library are necessary for the second processor. However, the disclosed technology can be implemented in some embodiments to provide the second processor that may be implemented by using the same framework and library as the first processor (framework and library used to implement the first processor).

Referring to FIG. 3, by way of example, the disclosed technology can be implemented in some embodiments to provide software for utilizing the second processor 122 included in the storage device 120. FIG. 3 illustrates an example of the access process indicated by A in FIG. 2.

As will be discussed below, the user uses software to generate a program that allows the second processor 122 to perform data processing or to generate a command in the program. Some embodiments discussed below may be applied to a command that is performed according to subsequent execution of software. In some implementations, the term “user input” can be used to indicate an input to the application that is provided by user.

In order to perform operations of an application (e.g., machine learning, data analysis or graph), the user may generate or use software at an application framework level (300). The user may perform a software task associated with an operation to be processed by the second processor 122 through the same application framework as a software task associated with an operation to be processed by the first processor 110 (310). Also, the user may perform a software task associated with an operation to be processed by the second processor 122 using the same library as a software task associated with an operation to be processed by the first processor 110 (320). For example, instead of separately generating a code for supporting an operation by the second processor 122, the user may generate software capable of supporting an operation to be performed by the second processor 122 using a function that is stored in a library to support the operation of the first processor 110.

In some implementations, referring to FIG. 3, the user is involved within the inner operations of the two processors as follows. For example, a user (e.g., programmer) may implement the first processor and the second processor by using the same framework and library. In addition, a user of a computer or mobile device may use a device and generate an input to the application installed in the device. In addition, the input may be processed by the host (e.g., CPU) in the device. An arithmetic operation may be performed by the CPU (e.g., first processer) or PIM (or NDP) processor (e.g., second processor). In some implementations, the first processor is a host processor, and the second processor is NDP processor. The first processor may be used to run the compiler.

Commands associated with the execution of software by the user may be classified when an instruction is generated by a compiler (330). In some implementations, the compiler may include a computer program or a program that translates computer code written in one programming language into another language. In one example, the compiler may be configured to generate an instruction according to a program executed by an external processor such as the first processor 110.

For example, the compiler may include a command extractor 400 to determine which of the first processor 110 and the second processor 122 will process or execute the command according to the execution of the software and to classify the command.

For example, the command extractor 400 may be implemented as an additional function in the compiler that is performed during the operation of the compiler by, and the command extractor 400 may be part of the source code of the compiler. The command extractor 400 of the compiler may check the characteristic or level of the operation corresponding to the command when generating an instruction according to the execution of the software. The command extractor 400 of the compiler may classify operations into (1) an operation to be performed by the second processor 122 and (2) an operation to be performed by the first processor 110, based on the operation to be performed according to the command.

In some implementations, the command extractor 400 of the compiler may check an operational intensity of the operation to be performed according to the command, when generating the instruction according to the program to be executed. The operational intensity may indicate a ratio between an operation amount and a data access amount for performing the operation according to the corresponding command.

$$Equation : Operational intensity = operation amount ( OPs ) / data access amount ( Bytes )$$

The operational intensity may be calculated on the basis of information on instruction set architecture (ISA).

The data access amount may indicate a frequency at which

the first processor 110 or the second processor 122 accesses the memory 121 to perform the operation according to the corresponding command. The operation amount may indicate at least one of the number and complexity of operations to be performed by the first processor 110 or the second processor 122 according to the corresponding command.

As the frequency at which the first processor 110 or the second processor 122 accesses the memory 121 to perform the operation according to the corresponding command decreases and the operation amount increases, the operational intensity may increase. As the frequency at which the first processor 110 or the second processor 122 accesses the memory 121 to perform the operation according to the corresponding command increases and the operation amount decrease, the operational intensity may decrease.

In some implementations, the storage device 120 may further include a cache memory in addition to the memory 121. For example, when the type of the storage device 120 is an NDP memory, the storage device 120 may include a cache memory. In this case, the first processor 110 or the second processor 122 may perform the operation according to the corresponding command by accessing the memory 121 and the cache memory. In this case, a frequency of accessing the cache memory may not be included in the data access amount. The command extractor 400 may calculate the data access amount by applying a weight (e.g., 1.1) to a frequency of access to the memory 121. Since a frequency of accessing the cache memory is taken into account, the accuracy of calculating the operational intensity may be improved. In a case that the type of the storage device 120 is a processing-in-memory, the storage device 120 may not include a cache memory, and in this case, the data access amount may be calculated on the basis of a frequency of access to the memory 121.

The command extractor 400 may compare the operational intensity of the operation to be performed according to the command with a preset reference value.

When the operational intensity of the operation to be performed according to the command is less than the preset reference value, the corresponding command may be transmitted to a second driver (342).

The second driver may be a driver that supports the operation of the second processor 122. The command transmitted to the second driver may be classified as the execution kernel of the second processor 122, and may be processed by the second processor 122. According to the received command, the second processor 122 may read data stored in the memory 121 and perform an operation on the read data. The second processor 122 may transmit a result of the data operation processed according to the received command to the first processor 110.

When the operational intensity of the operation to be performed according to the command is equal to or greater than the preset reference value, the corresponding command may be transmitted to a first driver (341).

The first driver may be a driver that supports an operation by the first processor 110. The command transmitted to the first driver may be classified as the execution kernel of the first processor 110, and may be processed by the first processor 110.

The command extractor 400 included in the compiler may classify commands into (1) a command to be processed by the second processor 122 and (2) a command to be processed by the first processor 110, depending on the operational intensity of an operation to be performed by a command. In some implementations, a command that requires a smaller operational intensity is processed by the second processor 122 and a command that requires a larger operational intensity is processed by the first processor 110, improving the data processing efficiency by the first processor 110 and the second processor 122. Here, for example, a command that requires an operational intensity that is smaller than a reference operational intensity is processed by the second processor 122 and a command that requires an operational intensity that is larger than a reference operational intensity is processed by the first processor 110. In some implementations, operations to be processed may be classified into operations to be processed by the first processor 110 and operations to be processed the second processor 122 depending on the characteristic or type of an operation other than the operational intensity of an operation. For example, in a case that an operation is performed to process data stored in the memory 121 and a result of the operation is stored in the memory 121, such an operation may be performed by the second processor 122 adjacent to the memory 121. In a case that an operation is performed to process data stored in the memory 121 and a result of the operation is used in the first processor 110 or is transmitted to an external device, such an operation may be performed by the first processor 110.

In some implementations, commands are automatically classified depending on an operational intensity that is obtained when the compiler generates an instruction to execute software, and thus it is possible to implement software for supporting an operation by the second processor 122 without requiring a separate framework or library. In some implementations, the user may create software using the same code and function as the first processor 110, and thus it is easy to construct software for using the second processor 122.

In this way, it is easy to construct software for performing an operation by the second processor 122 located in the storage device 120, and thus the data processing performance by the electronic device 100 including the first processor 110 may be improved by using the second processor 122 in addition to first processor 110.

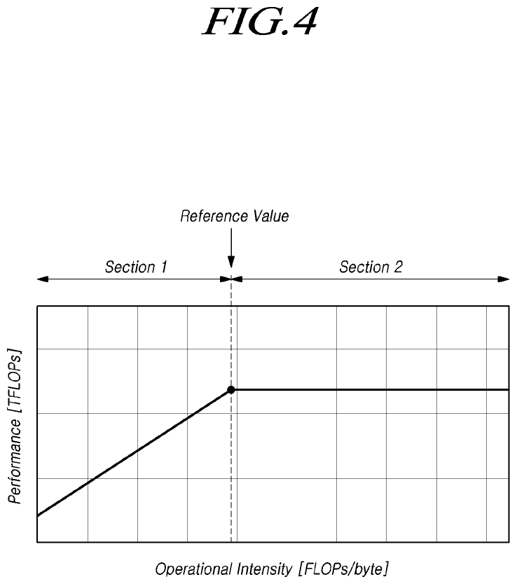

FIG. 4 is a diagram illustrating an example of a reference value serving as a classification criterion for classifying a command to be processed by a processor in the electronic device 100 based on an embodiment of the disclosed technology.

Specifically, FIG. 4 shows an example of the relationship between the operational intensity and the data processing performance.

A first section Section 1 may indicate that the data processing performance increases as the operational intensity increases. A second section Section 2 may indicate the data processing performance does not increase even when the operational intensity increases.

In a section, such as the first section Section 1, in which the data processing performance increases according to an increase in the operational intensity, it is possible to prevent a decrease in speed that would have caused by the data transmission and reception between the first processor 110 and the memory 121 by performing an operation by the second processor 122 located adjacent to the memory 121, thereby improving the overall data processing performance.

In a section, such as the second section Section 2, in which the data processing performance is constant regardless of an increase in the operational intensity, it may be advantageous in improving the overall performance of the electronic device 100 to process data by the first processor 110, which has a better performance than the second processor 122.

On the basis of the relationship between the operational intensity and the data processing performance, an operational intensity corresponding to the boundary between the first section Section 1 and the second section Section 2 may be set as a reference value Reference Value. In some implementations, the reference value Reference Value may be set to an operational intensity that is adjacent to the boundary between the first section Section 1 and the second section Section 2.

When the operational intensity of an operation to be performed by a command is less than the reference value Reference Value and is thus included in the first section Section 1, the operation according to the corresponding command may be performed by the second processor 122 to increase the data processing speed and improve the data processing performance of the electronic device 100.

When the operational intensity of an operation to be performed by a command is equal to or greater than the reference value Reference Value and is included in the second section Section 2, the operation according to the corresponding command may be performed by the first processor 110, different from the operation to be performed by the second processor 122.

Since the operation to be processed by the second processor 122 is distinguished from the operation to be processed by the first processor 110 based on the operational intensity, the data processing by the second processor 122, which is located adjacent to the memory 121 and performs a partial operation on data, can be performed efficiently.

Since operations are classified into an operation to be processed by the second processor 122 and an operation to be processed by the first processor 110 depending on the operational intensity when generating an instruction in the compiler, it is not necessary to construct a command corresponding to an operation to be processed by the second processor 122 in a separate work environment. The disclosed technology can also be implemented in some embodiments to improve the data processing performance of the electronic device 100 by increasing the utilization of data processing by the second processor 122 located inside the storage device 120.

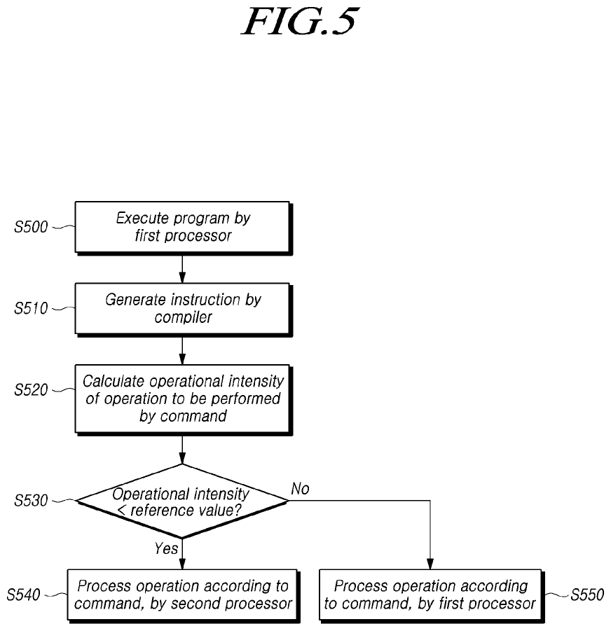

FIG. 5 is a diagram illustrating an example method for operating the electronic device 100 based on an embodiment of the disclosed technology.

Referring to FIG. 5, a program may be executed by the first processor 110 included in the electronic device 100 (S500).

In some implementations, a command constitutes the program executed by the first processor 110 and may be generated through a task that is performed using the same application framework and library as an application framework and library used to constitute a command for the second processor 122.

In some implementations, an instruction may be generated by the compiler according to the execution of the program (S510).

The operational intensity of an operation to be performed according to the command may be calculated by the command extractor 400 included in the compiler (S520). The command extractor 400 of the compiler may be included in the compiler in the form of, for example, a function.

The command extractor 400 may compare the operational intensity of the operation to be performed according to the command with a preset reference value (S530).

When the operational intensity of the operation to be performed according to the command is less than the reference value, the corresponding command may be transmitted to the second processor 122 which is located inside the memory 121 or adjacent to the memory 121. The operation according to the corresponding command may be performed by the second processor 122 (S540).

When the operational intensity of the operation to be performed according to the command is equal to or greater than the reference value, the operation according to the corresponding command may be performed by the first processor 110 (S550).

In this way, since an operation to be processed by the second processor 122 and an operation to be processed by the first processor 110 are distinguished depending on the operational intensity of an operation to be performed according to a command, software for operation processing by the second processor 122 may be easily implemented in the same work environment as software for operation processing by the first processor 110.

In addition, since a command for the first processor 110 and a command for the second processor 122 are not separately generated and the entity that processes commands are distinguished by comparing an operational intensity to a reference value, a command to be processed by each processor may not be fixed and may be easily adjusted.

For example, a reference value to be compared with an operational intensity may be adjusted depending on the operating state of the electronic device 100 or the operating state of the second processor 122 included in the storage device 120. A command to be processed by the second processor 122 and a command to be processed by the first processor 110 may be changed by adjusting the reference value. In some implementations, the same command may be processed by the second processor 122 or may be processed by the first processor 110. The processor that processes a command may vary depending on the operating state of a device.

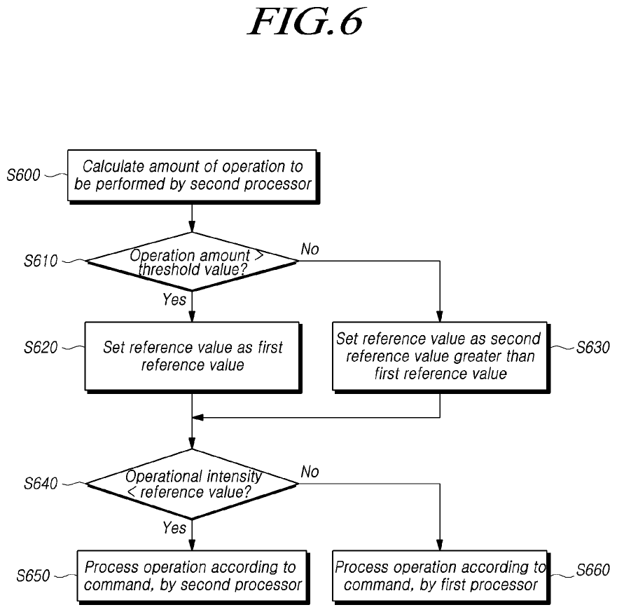

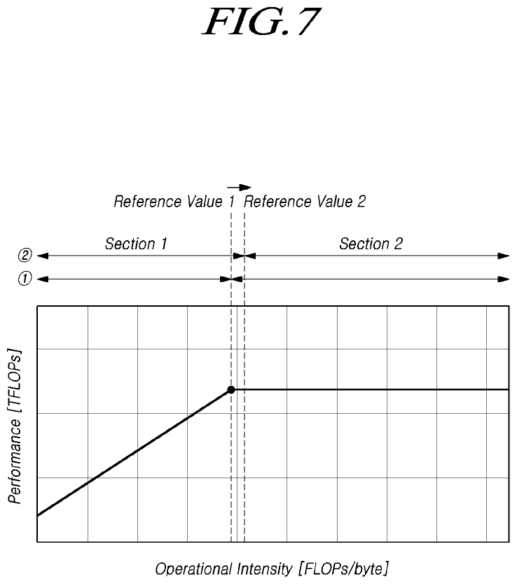

FIG. 6 is a diagram illustrating another example method for operating the electronic device 100 based on an embodiment of the disclosed technology. FIG. 7 is a diagram illustrating an example of a reference value that is adjusted according to the method illustrated in FIG. 6.

Referring to FIG. 6, a program may be executed by the first processor 110, and the compiler generates an instruction. Before comparing, with a reference value, the operational intensity of an operation to be performed according to a command, the reference value may be set.

In some implementations, the amount of an operation to be performed by the second processor 122 is calculated (S600). The amount of an operation may correspond to the total amount of operations to be performed for a predetermined period of time by the second processor 122, or may correspond to the total amount of operations to be performed by the second processor 122. According to the amount of the operation to be performed by the second processor 122, the range of a command to be processed by the second processor 122 may be adjusted.

The amount of the operation to be performed by the second processor 122 may be compared with a preset threshold value (S610). For example, when the amount of the operation to be performed by the second processor 122 is greater than the threshold value, the reference value to be compared with the operational intensity according to the command may be set as a first reference value (S620). When the amount of the operation to be performed by the second processor 122 is equal to or less than the threshold value, the reference value to be compared with the operational intensity according to the command may be set as a second reference value (S630). The second reference value may be a value that is greater than the first reference value.

In some implementations, the reference value may increase as an operation amount decreases, and may decrease as an operation amount increases.

The command extractor 400 included in the compiler may compare the operational intensity of an operation to be performed according to a command with a preset reference value (S640).

When the operational intensity is less than the reference value, the operation according to the corresponding command may be processed by the second processor 122 adjacent to the memory 121 (S650). When the operational intensity is equal to or greater than the reference value, the operation according to the corresponding command may be processed by the first processor 110 located outside the storage device 120 (S660).

Since a command for the first processor 110 and a command for the second processor 122 are generated in the same software work environment, a processor for processing a corresponding command may be flexibly determined or selected by adjusting the reference value. According to the operation states of the first processor 110 and the second processor 122 included in the electronic device 100, the range of a command to be processed by each processor may be easily adjusted. Since the ranges of an operation to be processed by the first processor 110 and an operation to be processed by the second processor 122 are not fixed and may be flexibly adjusted, data processing efficiency may be easily improved according to a situation in the electronic device 100 including the second processor 122 separate from the first processor 110.

In this way, in an embodiment of the disclosed technology, since software or a command in software to be processed by the second processor 122, which is located inside the memory 121 or adjacent to the memory 121, may be implemented in the same environment as software to be processed by the first processor 110, the software for the second processor 122 may be implemented more efficiently.

Accordingly, by increasing the data processing performance by the second processor 122, the data processing performance of the electronic device 100 may be improved by using the second processor 122 in addition to the first processor 110 which processes an operation on data stored in the memory 121.

Moreover, although the electronic device 100 discussed above includes the second processor 122 inside the memory 121 or adjacent to the memory 121 by way of example, in some implementations, commands can be processed by different types of processors and can be classified in the electronic device 100 including at least two processors. Since software for operation of different types of processors may be constructed in the same work environment, the electronic device 100 including the different types of processors may be efficiently implemented.

In some embodiments of the disclosed technology, since software for an internal processor that processes a part of an operation on data stored in a memory is constructed in the same work environment as software for an external processor, the memory including the internal processor may be easily implemented, and the utilization of the memory may be improved.

Only a few embodiments and examples are described. Enhancements and variations of the disclosed embodiments and other embodiments can be made based on what is described and illustrated in this patent document.

What is claimed is:

1. A storage device comprising:
a circuit board;
a memory disposed on the circuit board and including a plurality of memory cells configured to store data; and
an internal processor coupled to be in communication with the memory and configured to perform an operation on the data stored in the memory upon receipt of a command from an external device,
wherein the command is extracted based on an operational intensity of the operation to be performed in response to the command, in a process in which a compiler generates an instruction according to a program executed by an external processor that is disposed outside the memory and separate from the internal processor.

2. The storage device according to claim 1, wherein the compiler that runs on the external processor includes a command extraction function configured to distinguish a command to be performed by the internal processor from a command to be performed by the external processor depending on the operational intensity of the operation to be performed in response to the command.

3. The storage device according to claim 2, wherein the command to be performed by the internal processor and the command to be performed by the external processor are generated through a same application framework or generated using a same library.

4. The storage device according to claim 1, wherein, in a case that the operational intensity of the operation to be performed in response to the command is less than a preset reference value, the command is transmitted to the internal processor, and the operation is performed by the internal processor.

5. The storage device according to claim 1, wherein, in a case that the operational intensity of the operation to be performed in response to the command is equal to or greater than a preset reference value, the command is not transmitted to the internal processor.

6. The storage device according to claim 1, wherein, in a case that the operational intensity of the operation to be performed according to the command is equal to or greater than a preset reference value, the operation is performed by the external processor.

7. The storage device according to claim 1, wherein the operational intensity of the operation to be performed by the internal processor in response to the command is less than the operational intensity of the operation according to a command to be performed by the external processor.

8. The storage device according to claim 1, wherein the operational intensity of the operation to be performed in response to the command is compared with a reference value to determine whether to perform the operation by the internal processor, wherein the reference value is adjusted based on a total amount of operations to be performed by the internal processor.

9. The storage device according to claim 8, wherein the reference value is adjusted to be inversely proportional to a total amount of operations to be performed by the internal processor.

10. The storage device according to claim 1, the internal processor is located inside the memory.

11. The storage device according to claim 1, the internal processor is separate from the memory and is on the circuit board that is shared with the memory.

12. An electronic device comprising:
a first processor configured to perform a first operation on data stored in a memory; and
a second processor configured to perform a second operation on data stored in the memory in response to a command received from the first processor, wherein the command is extracted based on an operational intensity of an operation to be performed in response to the command, in a process in which a compiler generates an instruction according to a program executed by the first processor.

13. The electronic device according to claim 12, wherein the compiler includes a command extraction function configured to compare the operational intensity of the operation to be performed in response to the command with a preset reference value and transmits the command to the first processor or the second processor based on a comparison result between the operational intensity of the operation to be performed in response to the command and the preset reference value.

14. The electronic device according to claim 12, wherein a command for an operation to be performed by the first processor and a command for an operation to be performed by the second processor are generated using a same application framework and library.

15. The electronic device according to claim 12, wherein the second processor is located closer to the memory than the first processor.

16. The electronic device according to claim 12, wherein a length of a communication channel between the second processor and the memory is shorter than a length of a communication channel between the first processor and the memory.

17. A method for operating an electronic device, comprising:
executing a program by a first processor;
comparing an operational intensity of an operation to be performed in response to a command with a preset reference value, in a process in which a compiler generates an instruction according to the program; and
in a case that the operational intensity of the operation to be performed in response to the command is less than the preset reference value, processing the command by a second processor located outside the first processor, or in a case that the operational intensity of the operation to be performed in response to the command is equal to or greater than the present reference value, processing the command by the first processor.

18. The method according to claim 17, wherein a command to be processed by the first processor and a command to be processed by the second processor are generated using a same application framework and library.

19. The method according to claim 17, wherein the first processor and the second processor are configured to perform operations on data stored in a memory, and the second processor is located closer to the memory than the first processor.

20. The method according to claim 17, wherein a length of a communication channel between the second processor and a memory is shorter than a length of a communication channel between the first processor and the memory.
